(19) United States
(12) Patent Application Publication
(10) Pub. No.: US 2026/0332255 A1
(43) Pub. Date: Oct. 22, 2026

(54) METHODS, SYSTEMS, AND COMPUTER READABLE MEDIA FOR TEMPORALLY EXPANDED PREDICTION OF VALUES OF A PERFORMANCE METRIC OF A COMMUNICATION DEVICE UNDER TEST

(71) Applicant: Keysight Technologies, Inc., Santa Rosa, CA (US)

(72) Inventor: Vijay Anantha Murthy, Leander, TX (US)

(21) Appl. No.: 19/182,051

(22) Filed: Apr. 17, 2025

(51) Int. Cl. H04B 10/079; H04L 43/02; H04L 43/062; H04L 43/08

(52) U.S. Cl. CPC H04B 10/079; H04L 43/02; H04L 43/062; H04L 43/08

(57) ABSTRACT

A method for temporally expanded prediction of values of a performance metric of a communication device under test includes generating test traffic for testing performance of a communication device under test and transmitting the test traffic to the communication device under test. The method further includes receiving test traffic transmitted by the communication device under test, where the transmitting and the receiving are performed for a first time period. The method includes determining values of a performance metric of the communication device under test for the first time period and inputting, to at least one machine learning model, the values of the performance metric of the communication device under test for the first time period. The method further includes receiving, as output from the at least one machine learning model, predicted values of the performance metric of the communication device under test for a second time period that is longer than the first time period.

### TECHNICAL FIELD

The subject matter described herein relates to testing high speed communication systems. More particularly, the subject matter described herein relates to methods, systems, and computer readable media for temporally expanded prediction of values of a performance metric of a communication device under test that is or may be used in high speed communication systems.

### BACKGROUND

Characterizing the performance of high-speed communication devices, such as optical transceivers, involves transmitting data frames, such as Ethernet frames, to the devices and measuring performance of the devices. One performance measurement of an optical transceiver device is counts of forward error correction (FEC) codewords with specified numbers of symbol errors. For example, it may be desirable to know the number of FEC codewords with 1 symbol error, the number of FEC codewords with 2 symbol errors, the number of FEC codewords with 3 symbol errors, etc. It may also be desirable to verify the presence of symbol errors. When FEC codewords are transmitted, the receiver may verify that the codewords are received correctly without errors.

Because real world traffic is bursty in nature, long duration tests can be required to fully characterize the performance of a communication device under test. For example, if a FEC codeword symbol error test is run for a short time period, all of the codewords may have zero symbol errors, which is not representative of how a transceiver will perform over a long duration. However, running long duration tests needed to more fully characterize device performance is time and labor intensive.

Accordingly, in light of these and other difficulties, there exists a need for improved methods, systems, and computer readable media for temporally expanded prediction of values of a performance metric of a communication device under test.

### SUMMARY

A method for temporally expanded prediction of values of a performance metric of a communication device under test includes generating, by a test traffic generator, test traffic for testing performance of a communication device under test. The method further includes transmitting the test traffic to the communication device under test. The method further includes receiving, by a test traffic receiver, test traffic transmitted by the communication device under test, wherein the transmitting and the receiving are performed for a first time period. The method further includes determining, by the test traffic receiver and from the test traffic transmitted by the communication device under test, values of a performance metric of the communication device under test for the first time period. The method further includes inputting, to at least one machine learning model, the values of the performance metric of the communication device under test for the first time period. The method further includes receiving, as output from the at least one machine learning model, predicted values of the performance metric of the communication device under test for a second time period that is longer than the first time period.

According to another aspect of the subject matter described herein, generating the test traffic includes generating Ethernet frames for testing the communication device under test.

According to another aspect of the subject matter described herein, transmitting the test traffic to the communication device under test includes transmitting test traffic to an optical transceiver.

According to another aspect of the subject matter described herein, receiving the test traffic transmitted by the communication device under test includes receiving the test traffic transmitted by the test traffic generator through the optical transceiver.

According to another aspect of the subject matter described herein, inputting the values of the performance metric to at least one machine learning model includes inputting the values of the performance metric to a plurality of different machine learning models and receiving the output includes receiving a weighted combination of outputs from the machine learning models.

According to another aspect of the subject matter described herein, receiving, as output from the at least one machine learning model, the predicted values of the performance metric includes receiving predicted numbers of codewords having specified numbers of symbol errors.

According to another aspect of the subject matter described herein, receiving the predicted numbers of codewords having specified numbers of symbol errors includes receiving predicted numbers of forward error correction (FEC) codewords having the specified numbers of symbol errors.

According to another aspect of the subject matter described herein, receiving, as output and from the at least one machine learning model, the predicted values of the performance metric includes receiving a predicted temperature profile or power consumption of the communication device under test for the second time period.

According to another aspect of the subject matter described herein receiving, as output and from the at least one machine learning model, the predicted values of the performance metric includes tap settings of the communication device under test for the second time period.

According to another aspect of the subject matter described herein, the method for temporally expanded prediction of values of the performance metric of the communication device under test includes implementing the at least one machine learning model on at least one field programmable gate array of a test traffic generation system.

According to another aspect of the subject matter described herein, a system for temporally expanded prediction of values of a performance metric of a communication device under test is provided. The system includes a test traffic generator including at least one processor for generating test traffic for testing performance of a communication device under test and transmitting the test traffic to the communication device under test. The system further includes a test traffic receiver including at least one processor for receiving test traffic transmitted by the communication device under test, where the transmitting and the receiving are performed for a first time period, determining, from the test traffic transmitted by the communication device under test, values of a performance metric of the communication device under test for the first time period, input, to at least one machine learning model, the values of the performance metric of the communication device under test for the first time period, and receiving, as output from the at least one machine learning model, predicted values of the performance metric of the communication device under test for a second time period that is longer than the first time period.

According to another aspect of the subject matter described herein, the test traffic generator is configured to transmit the test traffic to an optical transceiver.

According to another aspect of the subject matter described herein, the test traffic receiver is configured to receive the test traffic transmitted by the test traffic generator through the optical transceiver.

According to another aspect of the subject matter described herein, the test traffic receiver is configured to provide the values of the performance metric generated for the first time period to a plurality of different machine learning models and receiving the output includes receiving a weighted combination of outputs from the machine learning models.

According to another aspect of the subject matter described herein, the test traffic receiver is configured to receive, as the output from the at least one machine learning model, predicted numbers of codewords having specified numbers of symbol errors.

According to another aspect of the subject matter described herein, the predicted numbers of codewords having specified numbers of symbol errors comprise predicted numbers of forward error correction (FEC) codewords having the specified numbers of symbol errors.

According to another aspect of the subject matter described herein, the test traffic receiver is configured to receive, as output from the at least one machine learning model, a predicted temperature profile or power consumption of the communication device under test for the second time period.

According to another aspect of the subject matter described herein, the test traffic receiver is configured to receive, as output and from the at least one machine learning model, tap settings of the communication device under test for the second time period.

According to another aspect of the subject matter described herein, the at least one processor of the traffic receiver comprises at least one field programmable gate array (FPGA).

According to another aspect of the subject matter described herein, a non-transitory computer readable medium having stored thereon executable instructions that when executed by a processor or a computer cause the computer to perform steps is provided. The steps include generating, by a test traffic generator, test traffic for testing performance of a communication device under test. The steps further include transmitting the test traffic to the communication device under test. The steps further include receiving, by a test traffic receiver, test traffic transmitted by the communication device under test, where the transmitting and the receiving are performed for a first time period. The steps further include determining, by the test traffic receiver and from the test traffic transmitted by the communication device under test, values of a performance metric of the communication device under test for the first time period. The steps further include inputting, to at least one machine learning model, the values of the performance metric of the communication device under test for the first time period. The steps further include receiving, as output from the at least one machine learning model, predicted values of the performance metric of the communication device under test for a second time period that is longer than the first time period.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating an exemplary system for testing a communication device under test and temporally expanded prediction of values of a performance metric of the communication device under test using at least one machine learning model;

FIGS. 2-4 illustrate example of predictions from python scripts implemented by an inference engine using random forest, deep neural network and agglomerative predictions;

FIG. 5 illustrates an example of steps or stages of preparing data and training machine learning models to generate the predicted performance metrics, such as those illustrated in FIGS. 2-4;

FIG. 6 illustrates another example of output predictions that may be produced by a machine learning inference engine;

FIGS. 7 and 8 illustrate examples of the use of a test traffic generator to test different configurations of a communication device under test and predict values of performance metrics of the communication device under test;

FIG. 9 illustrates the use of a test traffic generator and an ML inference engine to test one or more devices under test and predict long duration performance metrics of the devices under test from short duration test results; and

FIG. 10 is a flow chart illustrating an exemplary process for temporally expanded prediction of values of a performance metric of a communication device under test.

### DETAILED DESCRIPTION

Testing transceiver optics or cables (active or passive; copper or optical) in high-speed communications, such as 800G Ethernet or 1.6T Ethernet, is challenging when evaluating the bit error rate (BER) and FEC performance of transceivers to analyze the ability of transceivers to withstand high throughput traffic along with bursty errors and not result in frame loss issues (a high frame loss rate (FLR) results in retransmission, which results in lower bandwidth and higher latency).

Generally, an Ethernet test traffic generator is used to send data at a high rate to evaluate the BER and FEC performance of a communication device under test (e.g., a transceiver and/or a cable) for a small duration and display relevant statistics (FLR, BER, symbol errors for codewords) for the duration of the test. Another way to evaluate BER and FEC performance is by transmitting data traffic from a test traffic generator for a long duration, as it may be difficult to predict or simulate the occurrence of a bursty error in short-duration testing. Finding or simulating bursty errors in a long-duration test and debugging the bursty errors becomes another challenge, as it is time-consuming and complicated to accurately determine the time of occurrence of bursty errors and debug the bursty errors.

In tests that focus on characterizing the signal integrity of a transceiver or cable, short-duration tests can be executed, data from these tests can be collated, and machine-learning models can be run to predict BER and FEC performance for long-duration tests. This will reduce the time required to run and debug long-duration tests.

Test traffic generators can use FPGAs to generate Ethernet traffic for testing. As described herein, the same and/or additional FPGAs may be used to run ensemble machine-learning models that predict the values of the performance metric of the communication device under test. FPGAs are more efficient than graphics processing units (GPUs), as FPGAs are more energy efficient, have lower latencies, are easier to customize, and are easier to reconfigure, even in the field, with changes to ML algorithms. In addition, FPGAs are typically less expensive than GPUs.

In one example, a plurality of machine learning algorithms can be used to individually predict, from values of a performance metric determined or measured over a short duration test, values of the performance metric of a communication device under test for a longer time period. The outputs of the individual machine learning models can be combined such that the machine learning models form an ensemble machine learning model. The ensemble ML model can be trained using existing and test data to reliably predict the DUT's BER and FEC performance for a long-duration test. This will reduce the time spent testing these channels and devices under test, and machine learning models can be leveraged to predict performance of and improve devices under test with reduced lab testing time.

One ensemble machine learning model combines a random forest model and a deep neural network model. The outputs from the random forest model and the deep neural network model can be combined using weighted averaging, an autoencoder, or hierarchical clustering This approach will provide a reliable way to predict the BER and FEC performance characteristics of a channel or a communication device under test for high-speed Ethernet communication for 800G or 1.6T based on implementing ensemble machine learning methodologies in the FPGAs of the test traffic generator.

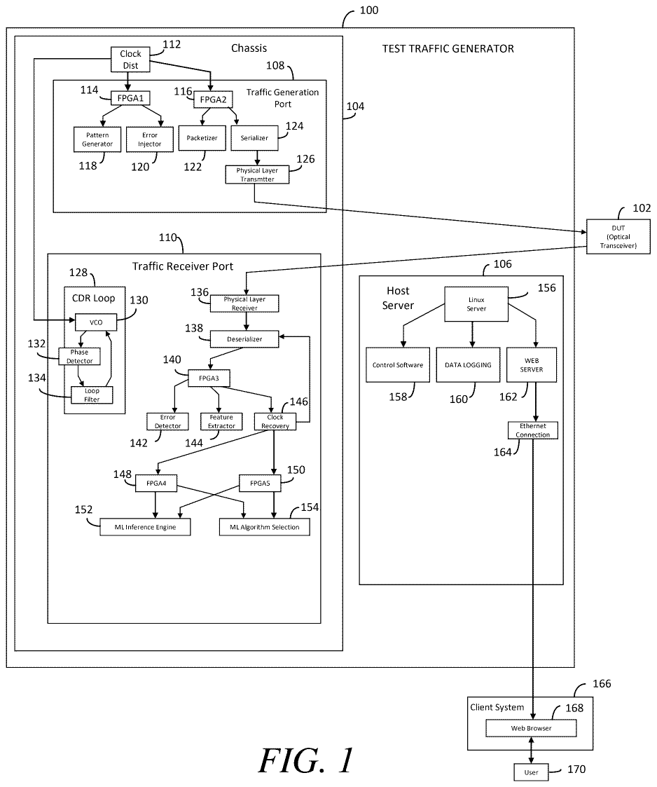

FIG. 1 is a block diagram illustrating an exemplary system for testing a communication device under test and temporally expanded prediction of values of a performance metric of the communication device under test using at least one machine learning model. Referring to FIG. 1, a test traffic generator 100 generates and sends test traffic to a communication device under test 102. In the illustrated example, communication device under test 102 is an optical transceiver. Test traffic generator 100 includes a chassis 104 and a host server 106. Chassis 104 includes a traffic generation port 108, a traffic receiver port 110, and a clock distributor. Traffic generation port 108 generates and transmits test packets to communication device under test 102 in the form of optical signals. Traffic receiver port 110 receives optical signals from communication device under test 102, converts the optical signals into a digital bitstream, converts the digital bitstream into packets, and analyzes the packets for errors. Clock distributor 112 distribute clock signals to traffic generator port 108 and traffic receiver port 110.

Traffic generation port 108 includes FPGAs 114 and 116. FPGAs 114 and 116 implement a pattern generator 118, an error injector 120, a packetizer 122, and a serializer 124. Pattern generator 118 generates bit patterns to be included in test packets transmitted to communication device under test 102. Error injector 120 inserts errors in at least some of the test packets. Packetizer 122 packetizes the bits received from pattern generator 118 into packets to be transmitted to communication device under test 102. Serializer 124 serializes the packets for transmission to communication device under test 102. Physical layer transmitter 126 transmits the serialized bits over the physical layer interface. For communication device under test 102, physical layer transmitter 126 may transmit the bits as an optical signal.

Traffic receiver port 110 includes a clock data recovery loop (CDR) 128 for recovering a clock signal transmitted by clock distributor 112. CDR loop 128 includes a voltage controlled oscillator (VCO) 130 that generates a local oscillator signal, a phase detector 132 that detects the phase of the clock signal, and a loop filter 134 that completes CDR loop 128. The clock signal output by CDR loop 128 is used by traffic receiver port 110 to receive packets from communication device under test 102 with a recovered clock signal that mimics the clock used by traffic generation port 108.

Traffic receiver port 110 further includes a physical layer receiver 136 that receives the optical signal transmitted by a communication device under test 102 and converts the optical signal into a bit stream. Deserializer 138 deserializes the bit stream into packets and provides the packets to FPGA 140. An error detector 142 detects errors in the received packets. In one example, error detector 142 may detect FEC codewords with symbol errors in the received packets. A feature extractor 144 extracts features from the received packets. A clock recovery circuit 146 performs clock recovery from the received packets and provides the recovered clock signal to deserializer 138. Clock recovery circuit 146 also provides the recovered clock signal to FPGAs 148 and 150. FPGAs 148 and 150 respectively implement machine learning inference engine 152 and machine learning algorithm selection module 154. Machine learning inference engine 152 implements an ensemble machine learning model that predicts values of a performance metric of communication device under test 102 based on performance metric values, such as numbers of FEC codewords with specified numbers of symbol errors detected by error detector 142. Machine learning algorithm selection module 154 selects among machine learning models used by inference engine 152 to generate the predicted performance metric values.

Host server 106 interfaces with external systems. Host server 106 includes a Linux server 156 that includes control software 158 for controlling the overall operation of test traffic generator 100, a data logging module 160 that logs test data and predicted test data generated by test traffic generator 100, and a web server 162 that interfaces with external systems. An Ethernet connection 164 provides a physical layer connection to an external system, such as client system 166. Client system 166 includes a web browser 168 through which a user 170 interacts with test traffic generator 100.

The following is an example of data flow through the system illustrated in FIG. 1.
1. Traffic Generation: FPGA 114 generates test patterns using pattern generator 118 and optionally injects errors using error injector 120. These patterns are packetized by FPGA 116 using packetizer 122.
2. Serialization and Transmission: The serialized data from the packetizer 122 is sent to the serializer (SerDesTX) 124, which converts the data into a serial format suitable for high-speed transmission. The physical layer transmitter 126 (PHYTX) then transmits the data to DUT 102.
3. Reception and Deserialization: DUT 102 returns the data to physical layer receiver (PHYRX) 136 at traffic receive port 110. Deserializer (SerDesRX) 138 converts the serial data into parallel form for further processing.
4. Error Detection and Feature Extraction: FPGA 140 processes the received data to detect errors using error detector 142, extracts relevant features using feature extractor 144, and synchronizes the data using clock recovery module 140.
5. Machine Learning Analysis: FPGA 148, with assistance from FPGA 150, applies machine learning models to the extracted features and detected errors using machine learning inference engine (MLInference) 152 and selects the appropriate algorithms using ML algorithm selection module (MLAlgoSelection) 154.
6. Control and Monitoring: Host server 106, using control software (ControlSW) 158, manages the entire process, logs data, and serves the web interface through web server 162.
7. User Interaction: User 170 interacts with the system through web browser 168 on the client system 166, accessing the system over Ethernet to configure tests, monitor performance, and analyze results.

### Additional Features

Clock distributor 112 ensures that all components are synchronized, which is important for accurate data processing and analysis. Data logging module 160 ensures that all test results are recorded for future analysis and verification.

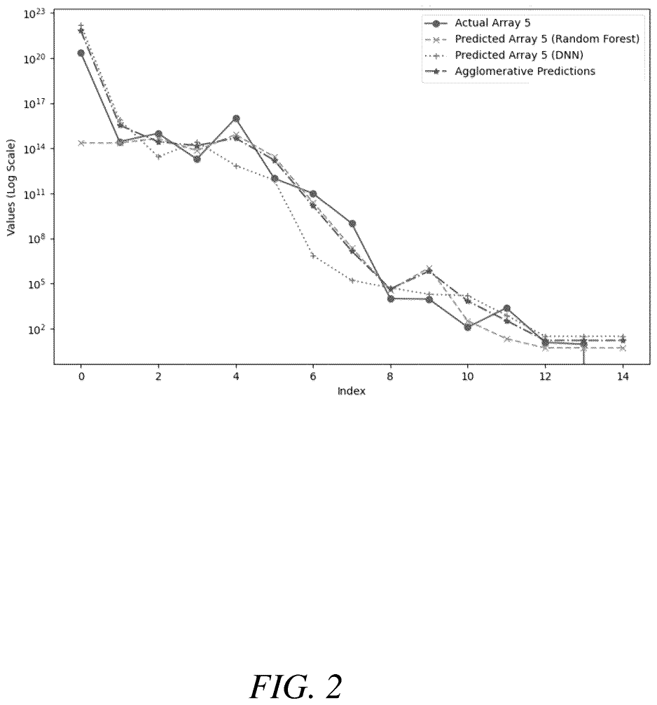

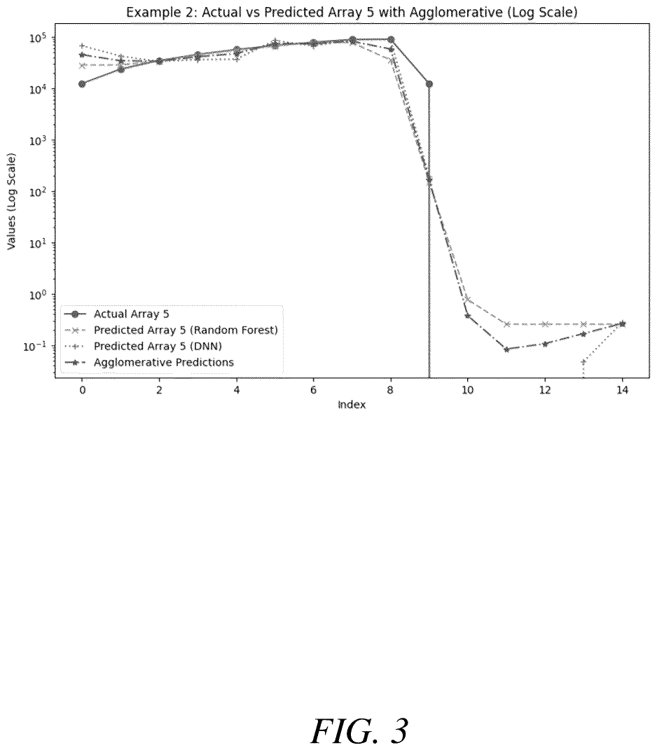

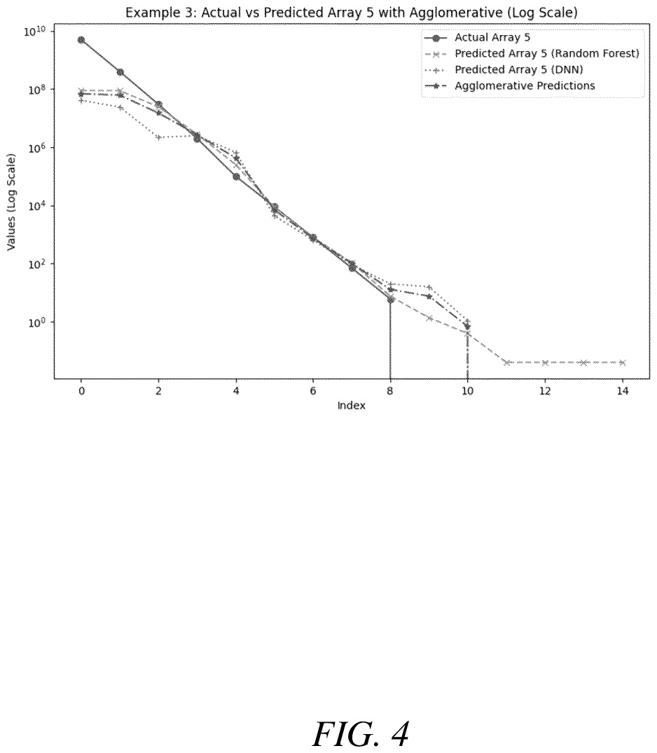

FIGS. 2-4 illustrate examples of predictions from Python scripts implemented by inference engine 152 using random forest, deep neural network and agglomerative predictions. In FIGS. 2-4, the values on the x axis are referred to as indices, where each index indicates FEC codewords with specified numbers of symbol errors. For example, the index 0 indicates FEC codewords with 0 symbol errors, the index 1 indicates FEC codewords with 1 symbol error, etc. The y axis indicates the number of FEC codewords having the numbers of symbol errors indicated by the values on the x axis.

The actual array data illustrated in FIGS. 2-4 was generated using test traffic generator 100 to send test packets to an array of devices under test and count FEC codewords with specified numbers of symbol errors. The actual array test was run for a long duration, e.g., 20 minutes. The predicted array (random forest) data illustrated in FIGS. 2-4 was generated by using test traffic generator 100 to send test packets to an array of devices under test and count FEC codewords with specified numbers of symbol errors for a short duration, e.g., 2 minutes, and using a random forest machine learning model to predict the numbers of FEC codewords with specified numbers of symbol errors for the same duration as the actual array test. The predicted array data illustrated in FIGS. 2-4 was generated by using test traffic generator 100 to send test packets to an array of devices under test and count FEC codewords with specified numbers of symbol errors for a short duration, e.g., 2 minutes, and using a deep neural network (DNN) machine learning model to predict the numbers of FEC codewords with specified numbers of symbol errors for the same duration as the actual array test. The agglomerative predictions data illustrated in FIGS. 2-4 was generated by combining the random forest and DNN predictions. The random forest model creates a reproducible randomness and consumes the data to train and produce the results. A deep neural network model independently trains on the same data by using multiple layers and uses short training sets to avoid overfitting and derives its output. Once these models have predictions, the data is inverse transformed to resemble the original inputs. The predictions may be combined using an empirically derived weighted averaging model to utilize the predictions from both the random forest and deep neural network models to create the ensemble model. This predicted output is provided as input to agglomerative clustering to accurately create clusters of codewords with 0,1,2 . . . 15 symbol errors.

The random forest and DNN ML models can be trained to predict the numbers of FEC codewords with specified numbers of symbol errors from short duration test data, such as counts of FEC codewords with specified numbers of errors as input and corresponding long duration test data as ground truth output. The ensemble model can be trained to combine the outputs from the FEC and DNN networks using similar inputs and outputs.

It can be seen from the data in FIGS. 2-4 that the predictions made by the machine learning models implemented by inference engine 152 closely approximate the actual FEC codeword errors generated by a device or devices under test in a long duration test.

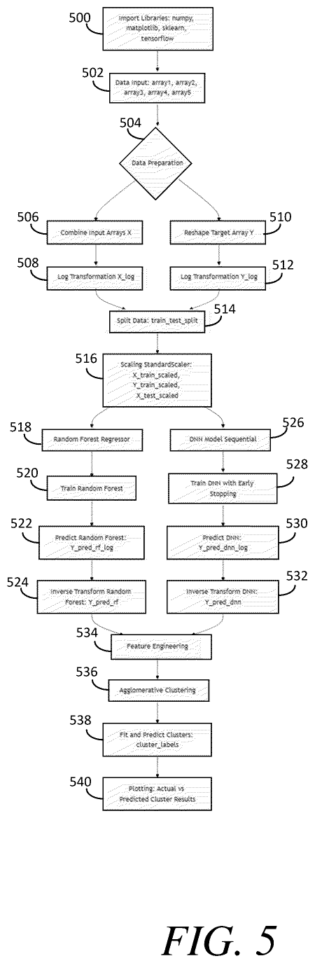

FIG. 5 illustrates an example of steps or stages of preparing data and training machine learning models to generate the predicted performance metrics, such as those illustrated in FIGS. 2-4. In FIG. 5, the process for generating the data includes importing machine learning model libraries (step 500) and importing input data (step 502), such as FEC codeword error data. The next step is data preparation (step 504) where data from actual performance tests of one or more devices under test is preprocessed into a format acceptable as input to machine learning models. In the illustrated example, data from different tests is illustrated by input arrays, where an input array is an array of devices under test. Data preparation includes combining the data from the input arrays (step 506) reshaping the data (step 508), and performing log transformations of the data. Data preparation also includes defining and transforming the target arrays for the predicted results (steps 510 and 512). The data is then divided into test and training sets (step 514) where the training set is used to train the machine learning models and the test set is used to validate performance of the machine learning models.

After converting the data into a 2 dimensional array for processing, we use a log transformation to avoid errors, especially when the data values are very close to zero or have a wide range and can easily become skewed. By normalizing data in this manner, the data can be better processed by machine learning models. Because random forest, deep neural network and agglomerative clustering are all independent models, the data is scaled (step 516) to ensure consistency and robustness of the output. Some of the acquired data is used for training, while other portions of the acquired data are used for testing to help the model learn and verify its outputs.

The random forest model (steps 518-522) creates a reproducible randomness and consumes the data to train and produce the results. A deep neural network model independently trains (steps 526-530) on the same data by using multiple layers and uses short training sets to avoid overfitting and derives its predictions. Once these models have predictions, the data is inverse transformed to resemble the original inputs (steps 524 and 532).

Feature engineering (step 534) is one part of the modeling process that directly impacts the quality of information available to the ensemble. Feature engineering helps by improving base learners, making patterns explicit, handling diverse data types, incorporating domain knowledge, and addressing inherent limitations, ultimately leading to more accurate, robust, and interpretable ensemble models

The predictions from the models are combined using empirically derived weighted averaging model to utilize the predictions from both the random forest and deep neural network models to create the ensemble model. This predicted output is provided as input to agglomerative clustering (step 536) to accurately create clusters of codewords with 0,1,2 . . . 15 symbol errors, which are fit into clusters, labeled, and plotted along with the actual clusters (steps 538 and 540).

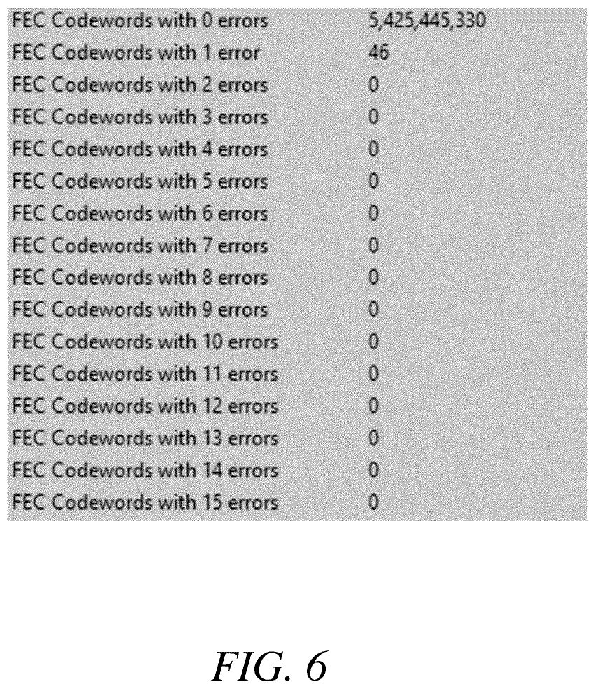

FIG. 6 illustrates another example of output predictions that may be produced by machine learning inference engine 152. In the illustrated example, the output indicates FEC codewords with specified numbers of symbol errors. The output illustrated in FIG. 6 may be generated by ML inference engine based on short duration test results for a first time period and may contain FEC codeword symbol error predictions for a longer duration test.

In general, a short duration test results dataset is sufficient for ML inference engine 152 to predict the long duration test results. Short duration datasets, for example, datasets at 1, 3, 5, 7,10 minute intervals may be used by inference engine 152 to predict 20 minute interval test results. The predicted 20 minute interval test results may be compared to actual 20 minute interval test results to learn and modify the weights for the ML models implemented by ML inference engine 152. In one example, ML inference engine 152 may include a supervised model that continually updates its weights using training data and corresponding real test data or an unsupervised model which receives only training data samples and predicts the long duration symbol errors.

The subject matter described herein is not limited to predicting symbol errors in FEC codewords In other examples, ML inference engine 152 may take, as input, measurements of any performance metric of a communication device under test for a short duration test and may predict values of the performance metric for a long duration test. Examples of other performance metrics include temperature values of a communication device under test, such as an optical transceiver, power consumption of the device under test, or tap settings of the optical transceiver. Temperature values may include measured temperature values of the communication device under test as the communication device under test receives and loops test signals back to test traffic generator 100. Measuring tap settings of communication device under test may include measuring voltages at different times during a test for the purpose of determining amounts of equalization required to keep each link stable. For the case of link training in high-speed Ethernet, the transmitter and receiver at both ends of the link continuously negotiate and optimize their parameters to ensure a high quality signal is transmitted and received at both ends to ensure both links are up, including accounting for channel losses. This link training process includes default tap settings, such as transmitting pre-defined patterns to the receiver. The receiver receives and verifies these patterns and sends feedback to the transmitter. The transmitter in-turn updates its tap settings to ensure a better signal is received by receiver. The ensemble machine learning model, given pre-defined tap settings and understanding the channel characteristic, is able to predict the best possible tap settings which might be needed on both ends for link up. Instead of a standard iterative process that can sometimes take a very long time, an ensemble machine learning model with only a few iterations can automatically program the actual tap settings and help bring up links very quickly.

In addition, although the examples described herein relate to testing and predicting performance metrics of optical transceivers and cables, the subject matter described herein is not limited to testing and predicting performance metrics of optical transceivers and cables. Other examples of communication devices under test whose performance can be evaluated using the methodology described herein include, active optical cables (AOCs), active electrical cables (AECs), active copper cables (ACCs), passive direct attach copper cables (DACs), etc.

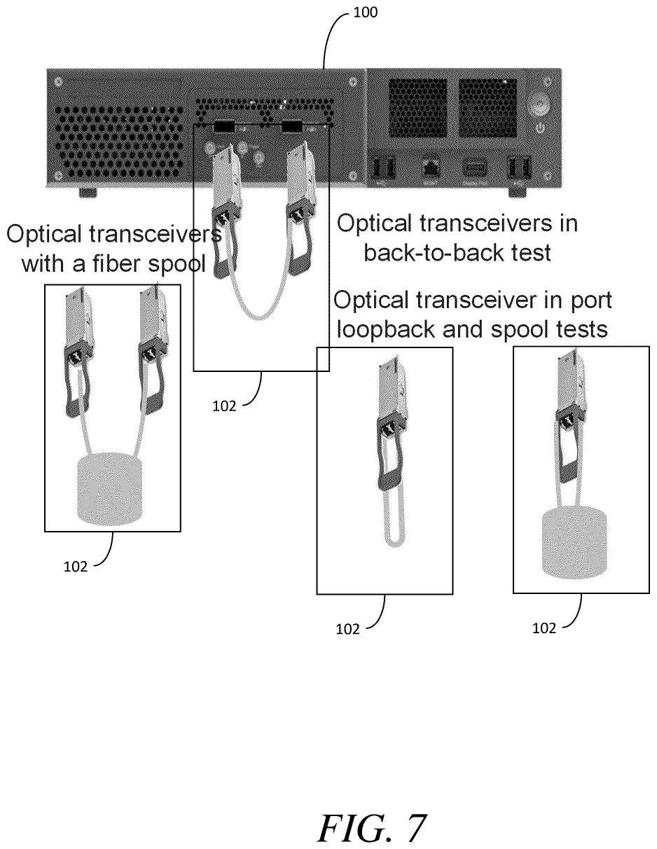

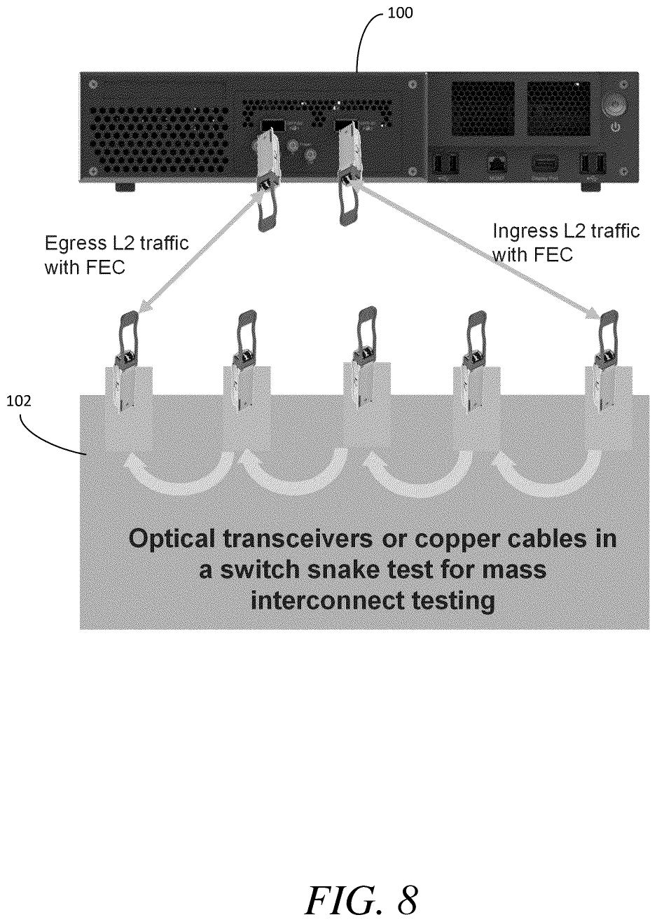

FIGS. 7 and 8 illustrate examples of the use of test traffic generator 100 to test different configurations of communication device under test 102 and predict values of performance metrics of communication device under test 102. In FIG. 7, communication device under test 102 includes one or more optical transceivers and either a fiber loop or a fiber spool. The optical transceivers are connected to ports of test traffic generator 100 and used to carry signals from the transmit port to the receive port of test traffic generator 100, either using a short loop of optical cable or a spool of optical cable. In FIG. 8, communication device under test 102 includes a plurality of optical transceivers connected in series between the transmit and receive ports of test traffic generator 100.

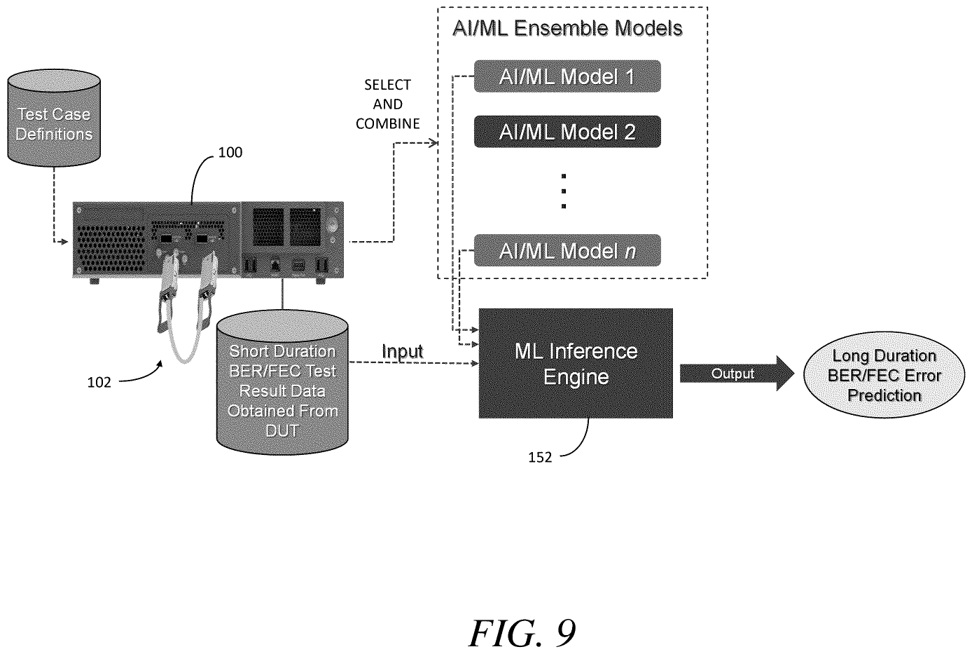

FIG. 9 illustrates the use of a traffic generator and an ML inference engine to test one or more devices under test and predict long duration performance metrics of the devices under test from short duration test results. Referring to FIG. 9, test traffic generator 100 is connected to two optical transceivers and an optical fiber loop. The two optical transceivers and the optical fiber loop comprise the communication device under test 102. Test traffic generator 100 receives test case definitions for transmitting data from the transmit port of test traffic generator 100 to the receive port of traffic generator 100 via communication device under test 102. The test case definitions may be short duration tests. Test traffic generator 100 generates output, such as FEC codewords, test results, or other output and provides that data as input to ML inference engine 152. ML inference engine 152 selects one or more machine learning models to predict long duration values of the performance metric.

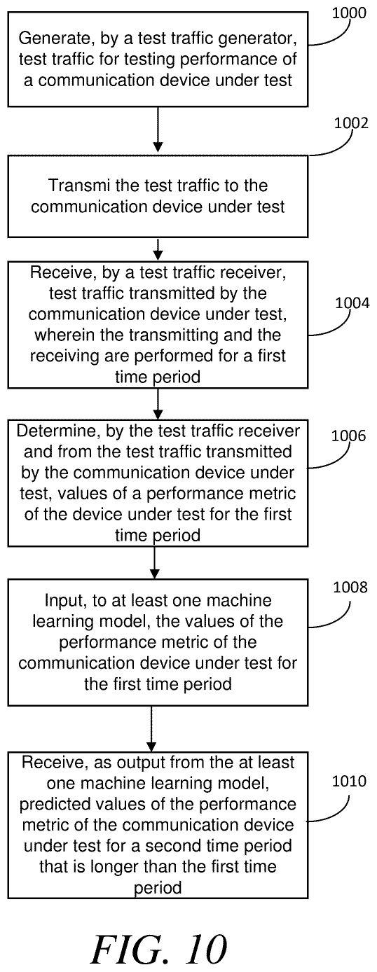

FIG. 10 is a flow chart illustrating an exemplary process for temporally expanded prediction of values of a performance metric of a communication device under test. Referring to FIG. 10, in step 1000, the process includes generating, by a test traffic generator, test traffic for testing performance of a communication device under test. For example, a test traffic generator, such as test traffic generator 100, may generate test traffic that includes FEC codewords to be transmitted to a communication device under test, such as an optical transceiver.

In step 1002, the process includes transmitting the test traffic to the communication device under test. For example, a test traffic generator, such as test traffic generator 100, may serialize and transmit the test traffic from one of the output ports of test traffic generator 100.

In step 1004, the process includes receiving, by a test traffic receiver, test traffic transmitted by the communication device under test, wherein the transmitting and the receiving are performed for a first time period. For example, a receive port of a test traffic generator, such as test traffic generator 100, may receive data transmitted from the communication device under test. The data received may be for a short duration test, such as a test lasting less than 10 minutes.

In step 1006, the process includes determining, by the test traffic receiver and from the test traffic transmitted by the communication device under test, values of a performance metric of the communication device under test for the first time period. For example, the receive port of a communication device under test, such as communication device under test 102, may receive test traffic from the communication device under test, deserialize the traffic, detect FEC codewords, and count FEC codewords with specified numbers of symbol errors.

In step 1008, the process includes inputting, to at least one machine learning model, the values of the performance metric of the communication device under test for the first time period. For example, a test device, such as test traffic generator 100, may implement one or more machine learning models and input the measured numbers of FEC codewords with specified numbers of symbol errors for the short duration test to each of the one or more machine learning models.

In step 1010, the process includes receiving, as output from the at least one machine learning model, predicted values of the performance metric of the communication device under test for a second time period that is longer than the first time period. For example, the machine learning models may be trained to predict values of the performance metric that would occur in a longer duration test than the test for which the data was input to the machine learning models. The performance metric include, for example, FEC codewords with specified numbers of symbol errors, temperature values of the communication device under test, or tap settings of the communication device under test or power consumed by the communication device under test.

Exemplary advantages of the subject matter described herein include providing the ability to characterize the long term performance of a communication device under test using results from a short duration test. Another advantage of the subject matter described herein is the ability to model long bursty errors and predict corresponding performance. The testing methodology described herein improves system design while reducing testing costs. Further, the subject matter described herein can be used to predict received signal histograms based on statistical data to enable better diagnostics and improve signal integrity.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for temporally expanded prediction of values of a performance metric of a communication device under test, the method comprising:
generating, by a test traffic generator, test traffic for testing performance of a communication device under test;
transmitting the test traffic to the communication device under test;
receiving, by a test traffic receiver, test traffic transmitted by the communication device under test, wherein the transmitting and the receiving are performed for a first time period;
determining, by the test traffic receiver and from the test traffic transmitted by the communication device under test, values of a performance metric of the communication device under test for the first time period;
inputting, to at least one machine learning model, the values of the performance metric of the communication device under test for the first time period; and
receiving, as output from the at least one machine learning model, predicted values of the performance metric of the communication device under test for a second time period that is longer than the first time period.

2. The method of claim 1 wherein generating the test traffic includes generating Ethernet frames for testing the communication device under test.

3. The method of claim 1 wherein transmitting the test traffic to the communication device under test includes transmitting test traffic to an optical transceiver.

4. The method of claim 3 wherein receiving the test traffic transmitted by the communication device under test includes receiving the test traffic transmitted by the test traffic generator through the optical transceiver.

5. The method of claim 1 wherein inputting the values of the performance metric to at least one machine learning model includes inputting the values of the performance metric to a plurality of different machine learning models and wherein receiving the output includes receiving a weighted combination of outputs from the machine learning models.

6. The method of claim 1 wherein receiving, as output from the at least one machine learning model, the predicted values of the performance metric includes receiving predicted numbers of codewords having specified numbers of symbol errors.

7. The method of claim 6 wherein receiving the predicted numbers of codewords having specified numbers of symbol errors includes receiving predicted numbers of forward error correction (FEC) codewords having the specified numbers of symbol errors.

8. The method of claim 1 wherein receiving, as output and from the at least one machine learning model, the predicted values of the performance metric includes receiving a predicted temperature profile of the communication device under test for the second time period.

9. The method of claim 1 wherein receiving, as output and from the at least one machine learning model, the predicted values of the performance metric includes tap settings of the communication device under test for the second time period.

10. The method of claim 1 comprising implementing the at least one machine learning model on at least one field programmable gate array of a test traffic generation system.

11. A system for temporally expanded prediction of values of a performance metric of a communication device under test, the system comprising:
a test traffic generator including at least one processor for generating test traffic for testing performance of a communication device under test and transmitting the test traffic to the communication device under test; and
a test traffic receiver including at least one processor for receiving test traffic transmitted by the communication device under test, wherein the transmitting and the receiving are performed for a first time period, determining from the test traffic transmitted by the communication device under test, values of a performance metric of the communication device under test for the first time period, input, to at least one machine learning model, the values of the performance metric of the communication device under test for the first time period, and receiving, as output from the at least one machine learning model, predicted values of the performance metric of the communication device under test for a second time period that is longer than the first time period.

12. The system of claim 11 wherein the test traffic generator is configured to transmit the test traffic to an optical transceiver.

13. The system of claim 12 wherein the test traffic receiver is configured to receive the test traffic transmitted by the test traffic generator through the optical transceiver.

14. The system of claim 11 wherein the test traffic receiver is configured to provide the values of the performance metric generated for the first time period to a plurality of different machine learning models and wherein receiving the output includes receiving a weighted combination of outputs from the machine learning models.

15. The system of claim 11 wherein the test traffic receiver is configured to receive, as the output from the at least one machine learning model, predicted numbers of codewords having specified numbers of symbol errors.

16. The system of claim 15 wherein the predicted numbers of codewords having specified numbers of symbol errors comprise predicted numbers of forward error correction (FEC) codewords having the specified numbers of symbol errors.

17. The system of claim 11 wherein the test traffic receiver is configured to receive, as the output from the at least one machine learning model, a predicted temperature profile or power consumption of the communication device under test for the second time period.

18. The system of claim 11 wherein the test traffic receiver is configured to receive, as the output and from the at least one machine learning model, tap settings of the communication device under test for the second time period.

19. The system of claim 11 wherein the at least one processor of the test traffic receiver comprises at least one field programmable gate array (FPGA).

20. A non-transitory computer readable medium having stored thereon executable instructions that when executed by a processor or a computer cause the computer to perform steps comprising:
generating, by a test traffic generator, test traffic for testing performance of a communication device under test;
transmitting the test traffic to the communication device under test;
receiving, by a test traffic receiver, test traffic transmitted by the communication device under test, wherein the transmitting and the receiving are performed for a first time period;
determining, by the test traffic receiver and from the test traffic transmitted by the communication device under test, values of a performance metric of the communication device under test for the first time period;
inputting, to at least one machine learning model, the values of the performance metric of the communication device under test for the first time period; and
receiving, as output from the at least one machine learning model, predicted values of the performance metric of the communication device under test for a second time period that is longer than the first time period.
